(19) United States
(12) Patent Application Publication
(10) Pub. No.: US 2007/0045376 A1
(43) Pub. Date: Mar. 1, 2007

(54) Automatic triggering apparatus

(76) Inventors: Paul Gaudron, Stamford, CT (US); Jeff Warmolts, Glen Ellyn, IL (US)

Correspondence Address: CANTOR COLBURN, LLP, 55 GRIFFIN ROAD SOUTH, BLOOMFIELD, CT, 06002, US

(21) Appl. No.: 11/511,600

(22) Filed: Aug. 29, 2006

Related U.S. Application Data
(60) Provisional application No. 60/712,060, filed on Aug. 29, 2005.

(51) Int. Cl. B25C 1/14

(52) U.S. Cl. 227/10

(57) ABSTRACT

A remote triggering device for a setting tool that includes a setting tool; an extension having a spring with a spring rate greater than a spring rate in the setting tool, the extension being in operable communication with the setting tool; and a trigger actuator in operable communication with both the extension and the setting. A method for remote triggering of a setting tool that includes urging a setting tool and extension against a work piece; compressing a spring in the setting tool; compressing a spring in the extension subsequent to the compression of a spring in the setting tool; actuating a triggering bar; actuating a trigger of the setting tool; and discharging a fastener for the setting tool.

### CROSS REFERENCE TO RELATED APPLICATIONS

This application claims priority to provisional application 60/712,060 filed Aug. 29, 2005, the entire contents of which are incorporated herein by reference.

### BACKGROUND

As is the case with many fastening tools for use with fastening members, design consideration is given to ease of use and efficiency. In some circumstances, however, space requirements and/or location of fastener penetration makes use of such tools difficult. One such situation is where fasteners are intended to be set at a relatively long distance from where the user has access. This can occur in such places as relatively tall ceilings or where there are physical impediments to reaching a target area. In such cases, conventional power fastening tools are not employable. The loss of conventional fastening tools generally creates an increase in difficulty of setting the fastener and a decrease in efficiency of setting the fastener. For example, powder actuated fastening tools make quick work of setting fasteners in very hard substrate materials such as concrete and various metal alloys, however, where these cannot be employed, setting fasteners is a time consuming and laborious chore.

In order for such power tools to function, with safety in mind, compression of the tool against a work surface is required prior to that tool being capable of discharging a fastener. Since such compression is required, it would be highly difficult to utilize such a tool in a location that is beyond the reach of the user. Since it is desirable to use powder actuated setting tools to improve efficiency of material affixation, a solution to the barrier of use would be beneficial to the art.

### SUMMARY OF THE INVENTION

A remote triggering device for a setting tool that includes a setting tool; an extension having a spring with a spring rate greater than a spring rate in the setting tool, the extension being in operable communication with the setting tool; and a trigger actuator in operable communication with both the extension and the setting A method for remote triggering of a setting tool that includes urging a setting tool and extension against a work piece; compressing a spring in the setting tool; compressing a spring in the extension subsequent to the compression of a spring in the setting tool; actuating a triggering bar; actuating a trigger of the setting tool; and discharging a fastener for the setting tool.

### BRIEF DESCRIPTION OF THE FIGURES

FIG. 1 is a side elevation view of a setting tool and remote triggering mechanism.

### DETAILED DESCRIPTION

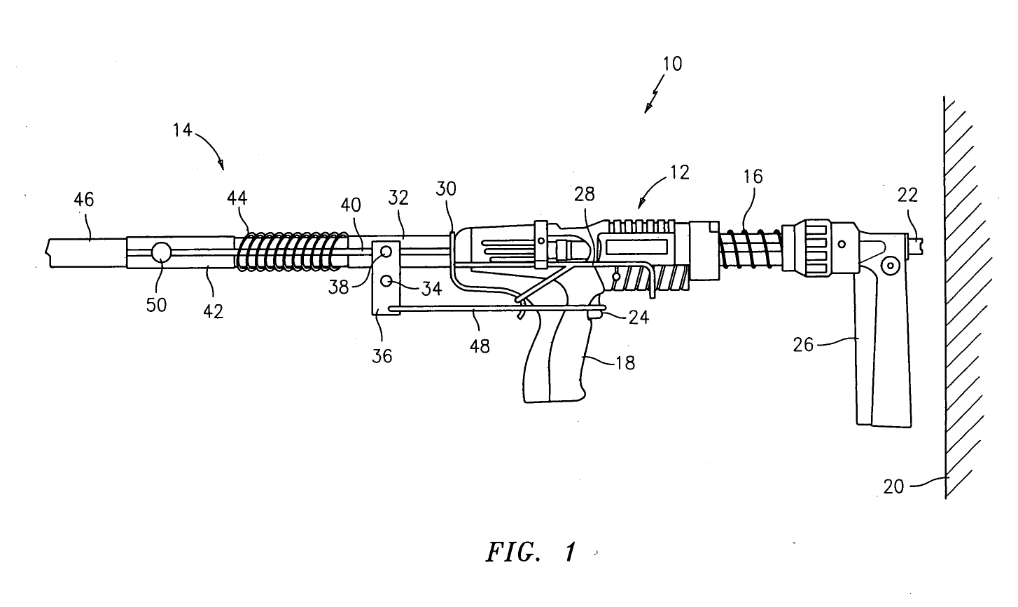

Referring to FIG. 1, a setting tool with remote triggering mechanism 10 is illustrated. A fastener setting portion 12 is illustrated at the right half of the drawing, while a remote triggering mechanism 14 is illustrated at the left portion of the drawing. One of ordinary skill in the art will recognize the fastener setting portion from powder actuated setting tool 12 as a Powers Fasteners, Inc. Product No. PA351 which is commercially available from Powers Fasteners, Inc., 2 Powers Square, New Rochelle, N.Y. 10801, and therefore does not require explicit discussion. Suffice it to say that the portion or fastening tool 12 requires compression of a spring(s) 16 by a user, which is effected by forcing a body 18 of the setting tool toward a work surface 20 with the setting tool nose 22 bearing against that surface 20. As this must occur prior to a trigger 24 functioning to release a firing pin (not visible in this drawing) to ignite a powder charge also not visible in this drawing to expel a fastener from a magazine 26 into the work piece of surface 20.

In the event that the setting tool 12 is required to be in a position beyond that which the user can grip 18, heretofore such setting tool 12 would not be useable in order to set the fastener. Disclosed herein is a device adaptable to the setting tool 12 which enables actuation of the trigger 24 after compression of the spring 16 even in a location where the user cannot physically reach the grip 18 of the setting tool 12. The remote triggering device 14 includes a retention bracket 28 to retain the setting tool 12 against a pressure transmission plate 30 which is attached at one end of the remote triggering device 14. The plate 30 is fixedly attached to a pivot sleeve 32 which itself supports a rocker pivot 34 and rocker 36. It will be noted that rocker 36 further includes a second pin 38 that rides in a slot 40 such that rocker 36 may be pivoted about pivot pin 34 based upon axial movement of trigger sleeve 42 consequent to compression of a triggering spring 44.

Once triggering spring 44 is compressed due to an axial load placed upon extension 46, sleeve 42 urges pin 38 toward setting tool 12 thereby causing an opposite end of rocker 36 to move away from setting tool 12 thereby drawing a trigger bar 48 in a direction calculated to cause trigger 24 to depress thereby discharging the setting tool.

It is to be noted that the spring rate of spring 44 is required to be carefully set such that compression of spring 16 in setting tool 12 and additionally other compressive springs in setting tool 12, (not shown herein but available in the commercial setting tool) will occur prior to compression of spring 44 ensuring that the setting tool 12 is put in a position wherein it is both safe to fire and capable of firing. Because the spring rate of spring 44 is higher than the spring rates of spring 16 and any other springs in the setting tool 12, it is impossible to force the sleeve 42 to move into contact with pin 38 prior to the setting tool springs being collapsed and putting the setting tool in position to fire. Therefore, all that is necessary is to continue to compress the entire assembly 10 whereafter once the force from the assembly 10 is sufficient to compress spring 44, the sleeve 42 simply slides within sleeve 32 and mechanically urges pin 38 toward setting tool 12. As noted above, the urging of pin 38 toward setting tool 12 causes pivoting action of rocker 36 on pivot point 34 thereby drawing trigger rod 48 leftwardly in the drawing which actuates trigger 24 to a firing position.

Sleeve 42 further includes a recess that is not visible in this drawing but which recess is axially provided in sleeve 42 such than the extension 46 may be received therein and pinned in place utilizing a pin 50 to secure it therein. Since different extensions 46 may be utilized, the tool may be placed at any practicable distance from the user and still be actuated through the device and arrangement disclosed herein.

Further disclosed herein is a method for remotely actuating a setting tool. The method includes urging an extension against a properly supported setting tool, the extension including a biasing member of greater spring rate than that required to compress any springs within the setting tool such that a force applied to the extension will cause the setting tool to move to an actuated position prior to the extension spring compressing and thereby causing actuation of the trigger.

What is claimed is:

1. A remote triggering device for a setting tool comprising:
a setting tool;
an extension having a spring with a spring rate greater than a spring rate in the setting tool, the extension being in operable communication with the setting tool; and
a trigger actuator in operable communication with both the extension and the setting tool.

2. The remote triggering device as claimed in claim 1 wherein the trigger actuator operates through a rocker at one end and through contact with the trigger at the other end.

3. The remote triggering device as claimed in claim 1 wherein the spring at the extension is slidably mounted to the extension.

4. The remote triggering device as claimed in claim 1 wherein the rocker automatically causes triggering of the setting tool upon compression of the spring at the extension.

5. The remote triggering device as claimed in claim 1 wherein the rocker is interengaged with the extension through a sleeve that is biased by the spring.

6. The remote triggering device as claimed in claim 5 wherein the sleeve provides a mounting position for a rocker including a pivot and an arcuate groove.

7. The remote triggering device as claimed in claim 1 wherein the trigger actuator further includes a trigger contact surface in contact with a trigger of the setting tool.

8. A method for remote triggering of a setting tool comprising:
urging a setting tool and extension against a work piece;
compressing a spring in the setting tool;
compressing a spring in the extension subsequent to the compression of a spring in the setting tool;
actuating a triggering bar;
actuating a trigger of the setting tool; and
discharging a fastener for the setting tool.

9. The method as claimed in claim 8 wherein the spring in the extension has a higher spring rate than the spring in the setting tool.

10. The method as claimed in claim 8 wherein the actuating the trigger bar is automatic upon compressing the spring in the extension.

11. The method as claimed in claim 8 wherein the actuating of the trigger of the setting tool occurs automatically following compression of the spring in the extension.
